(19) United States
(12) Patent Application Publication
(10) Pub. No.: US 2025/0376183 A1
(43) Pub. Date: Dec. 11, 2025

(54) DETERMINING DEVICE, STORAGE MEDIUM FOR STORING COMPUTER PROGRAM FOR DETERMINATION, AND METHOD FOR DETERMINATION

(71) Applicants: TOYOTA JIDOSHA KABUSHIKI KAISHA, Toyota-shi (JP); DENSO CORPORATION, Kariya-city (JP)

(72) Inventors: Hirofumi HANZAWA, Sapporo-shi (JP); Jumpei KIRIKI, Tokyo-to (JP); Kota HARADA, Tokyo-to (JP)

(73) Assignees: TOYOTA JIDOSHA KABUSHIKI KAISHA, Toyota-shi (JP); DENSO CORPORATION, Kariya-city (JP)

(21) Appl. No.: 19/070,954

(22) Filed: Mar. 5, 2025

(30) Foreign Application Priority Data
Jun. 10, 2024 (JP) 2024-093691

(51) Int. Cl. B60W 50/10; B60Q 1/34; B60W 30/18

(52) U.S. Cl. CPC B60W 50/10; B60Q 1/346; B60W 30/18163; B60W 2540/21; B60W 2552/10; B60W 2554/4041

(57) ABSTRACT

A determining device has a processor configured to determine whether a driver has requested to carry out automatic control for a vehicle action associated with operation information or the driver has requested to carry out manual control for the vehicle action, based on the operation information representing operation of a first operating device by the driver, and one or more from among action information representing a predetermined driver action by the driver, environment information representing a predetermined environment around the vehicle and a vehicle navigation route.

### FIELD

The present disclosure relates to a determining device, a storage medium storing a computer program for determination, and a method for determination.

### BACKGROUND

Automatic control devices that assist lane changing of vehicles have conventionally been mounted on vehicles. A driver can make a lane change by automatic control with the assistance of an automatic control device. The driver can also make a lane change with the vehicle manually, without the assistance of the automatic control device.

The driver may vary operation of a turn signal operation unit to communicate either a request for lane change by automatic control with the automatic control device, or manual operation of the lane change (see Japanese Unexamined Patent Publication No. 2020-163927, for example).

### SUMMARY

However, since communicating a request to the automatic control device requires the driver to change the manner of operating the turn signal operation unit, this has placed an extra burden on the driver.

It is an object of the present disclosure to provide a determining device that can reduce the burden on a driver, by determining whether the driver has requested to carry out automatic control or whether the driver has requested to carry out manual control, for a predetermined action of a vehicle.

(1) According to one embodiment, the present disclosure provides a determining device. The determining device has a determining unit that determines whether a driver has requested to carry out automatic control for a vehicle action associated with operation information or the driver has requested to carry out manual control for the vehicle action, based on the operation information representing operation of a first operating unit by the driver, and one or more from among action information representing a predetermined driver action by the driver, environment information representing a predetermined environment around the vehicle and a vehicle navigation route.

(2) In the determining device of embodiment (1), it is preferred that the action information has driver operation of a second operating unit different from the first operating unit, orientation of a face of the driver in a predetermined direction, and driver vocalization.

(3) In the determining device of embodiment (1) or (2), it is preferred that the processor is further configured to determine whether the driver has requested to carry out automatic control of the vehicle action or the driver has requested to carry out manual control of the vehicle action, based on order of generation of the operation information and generation of the action information.

(4) In the determining device of embodiment (1), it is preferred that the first operating device is a turn signal operation device that inputs a direction of a lane change by the vehicle and the vehicle action is the lane change associated with the turn signal operation device, and the processor is further configured to determine that the driver has requested to carry out manual control of the vehicle action when the direction of the lane change of the vehicle represented by the operation information matches the orientation of the face of the driver represented by the action information.

(5) In the determining device of embodiment (1), it is preferred that the environment information represents another vehicle around the vehicle.

(6) In the determining device of embodiment (5), it is preferred that the first operating device is a turn signal operation device that inputs a direction of a lane change by the vehicle and the vehicle action is the lane change associated with the turn signal operation device, and the processor is further configured to determine that the driver has requested to carry out automatic control of the vehicle action when the environment information shows that another vehicle is located in the direction of the lane change of the vehicle represented by the operation information.

(7) In the determining device of embodiment (1), it is preferred that the first operating device is a turn signal operation device that inputs a direction of a lane change by the vehicle and the vehicle action is the lane change associated with the turn signal operation device, and the processor is further configured to determine that the driver has requested to carry out manual control of the vehicle action when the direction of the lane change of the vehicle, represented by the operation information, is different from the moving direction of the vehicle toward the destination location of the vehicle, represented in the navigation route.

(8) According to another embodiment, a storage medium storing a computer program for determination is provided. The computer program product for determination includes determining whether a driver has requested to carry out automatic control for a vehicle action associated with operation information or the driver has requested to carry out manual control for the vehicle action, based on the operation information representing operation of a first operating device by the driver, and one or more from among action information representing a predetermined driver action by the driver, environment information representing a predetermined environment around the vehicle and a vehicle navigation route.

(9) According to yet another embodiment of the invention, a method for determination is provided. The method for determination includes determining whether a driver has requested to carry out automatic control for a vehicle action associated with operation information or the driver has requested to carry out manual control for the vehicle action, based on the operation information representing operation of a first operating device by the driver, and one or more from among action information representing a predetermined driver action by the driver, environment information representing a predetermined environment around the vehicle and a vehicle navigation route.

Since the determining device of the disclosure determines whether a driver has requested to carry out automatic control for vehicle action or whether the driver has requested to carry out manual control for vehicle action based on predetermined other information in addition to operation information, the determining device can reduce burden on the driver.

The object and advantages of the invention will be realized and attained by means of the elements and combinations particularly specified in the claims. It is to be understood that both the foregoing general description and the following detailed description are exemplary and explanatory and are not restrictive of the invention, as claimed.

### BRIEF DESCRIPTION OF DRAWINGS

FIG. 1A is a diagram illustrating operation of an automatic control device of the first embodiment in overview, and showing a vehicle.

FIG. 1B is a diagram illustrating operation of an automatic control device of the first embodiment in overview, and showing the interior of the vehicle.

FIG. 2 is a hardware configuration diagram for a vehicle in which the automatic control device of the first embodiment is mounted.

FIG. 3 is an example of an operation flow chart for determination processing by the automatic control device of the first embodiment.

FIG. 4 is an example of an operation flow chart for determination processing by the automatic control device of the second embodiment.

FIG. 5 is an example of an operation flow chart for determination processing by the automatic control device of the third embodiment.

FIG. 6 is an example of an operation flow chart for determination processing by the automatic control device of the fourth embodiment.

FIG. 7 is an example of an operation flow chart for determination processing by the automatic control device of the fifth embodiment.

### DESCRIPTION OF EMBODIMENTS

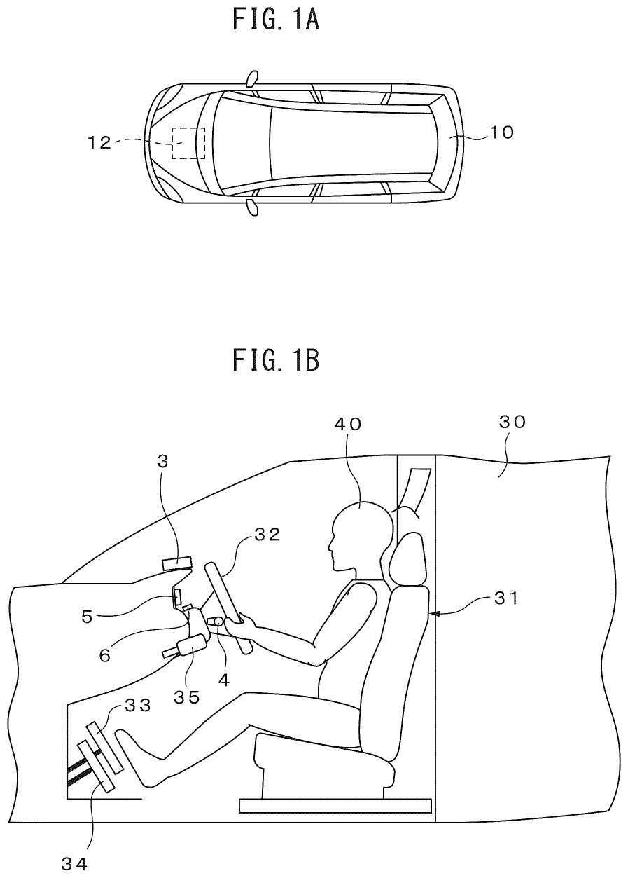

FIG. 1A and FIG. 1B are diagrams showing operation of an automatic control device according to the first embodiment, in overview. FIG. 1A shows a vehicle, and FIG. 1B shows the interior of the vehicle.

As shown in FIG. 1A, the vehicle 10 has an automatic control device 12. The automatic control device 12 has a self-driving mode wherein the vehicle 10 is driven primarily by the automatic control device 12 (for example, driving mode with levels 3 to 5) and a manual driving mode in which the vehicle 10 is driven primarily by the driver 40 (for example, driving mode with levels 0 to 2). The automatic control device 12 is an example of the determining device. The vehicle 10 may also be an autonomous vehicle.

In manual driving mode, the automatic control device 12 controls the action of the vehicle 10 based on operation by the driver 40. The driver 40 sits in the driving seat 31 in the cabin 30 in a manner allowing control of the steering wheel 32, brake pedal 33, accelerator pedal 34 and shift operating unit 35.

Even in self-driving mode, the driver 40 is still able to partially control the vehicle 10. For example, in self-driving mode the driver 40 can make a lane change by operating the steering wheel 32. Operation by the driver 40 overrides operation by the automatic control device 12.

Likewise, even in manual driving mode, the automatic control device 12 is still able to partially control the vehicle 10. For example, in manual driving mode the automatic control device 12 makes lane changes in response to requests by the driver 40.

Based on operation information representing operation by the driver 40 of a predetermined operating unit, and on predetermined other information, the automatic control device 12 determines whether the driver 40 has requested to carry out automatic control for vehicle action associated with the operation information, or whether the driver 40 has requested to carry out manual control for the vehicle action. The predetermined operating unit is an example of the predetermined operating device.

An example of predetermined other information includes action information representing a predetermined driver action by the driver 40. The automatic control device 12 acquires action information using monitor images that include the face of the driver 40, acquired by a monitoring camera 3. The automatic control device 12 identifies facial orientations of the driver 40 represented in the monitor images. The facial orientation of the driver 40 is an example of action information representing a driver action. Other information includes environment information representing the predetermined environment around the vehicle 10, and the navigation route for the vehicle 10.

Operation of the turn signal operation unit 4 by the driver 40 is represented in the operation information. A lane change is an example of vehicle action associated with operation information representing operation of the turn signal operation unit 4 by the driver 40.

When the driver 40 desires to make a lane change, the driver operates the turn signal operation unit 4. The driver 40 indicates the direction of the lane change of the vehicle 10 by operating the turn signal operation unit 4 either upward or downward. Request for a lane change can be made in automatic control mode and in manual control mode.

When the direction of the lane change of the vehicle 10 represented by the operation information for the turn signal operation unit 4 matches the facial orientation of the driver 40 represented by the action information, the automatic control device 12 determines that the driver 40 has requested to carry out the lane change by manual control.

If the driver 40 is looking in the direction in which the vehicle 10 is to move when the turn signal operation unit 4 has been operated, this indicates that the driver 40 is actively confirming the situation in the direction in which the vehicle 10 is to move. It is likely that the driver 40 intends to make the lane change by their own operation of the vehicle 10.

The automatic control device 12 flashes a direction indicator (not shown) depending on indication of the direction of the lane change of the vehicle 10, but the automatic control device 12 controls action of the vehicle 10 for lane changing of the vehicle 10 based on operation by the driver 40.

When the direction of the lane change of the vehicle 10 representing operation of the turn signal operation unit 4 by the driver 40 does not match the facial orientation of the driver 40 represented by the action information, the automatic control device 12 determines that the driver 40 has requested to carry out the lane change by automatic control.

If the driver 40 is not looking in the direction in which the vehicle 10 is to move when the turn signal operation unit 4 has been operated, this indicates that the driver 40 is not actively confirming the situation in the direction in which the vehicle 10 is to move. It is likely that the driver 40 does not intend to make the lane change by their own operation of the vehicle 10.

The automatic control device 12 flashes a direction indicator (not shown) depending on indication of the direction of the lane change of the vehicle 10, and controls action of the vehicle 10 for lane changing of the vehicle 10.

Since as explained above, the automatic control device 12 of the embodiment determines whether the driver 40 has requested to carry out automatic control for vehicle action or whether the driver 40 has requested to carry out manual control for vehicle action based on predetermined other information in addition to operation information, burden on the driver 40 can be reduced.

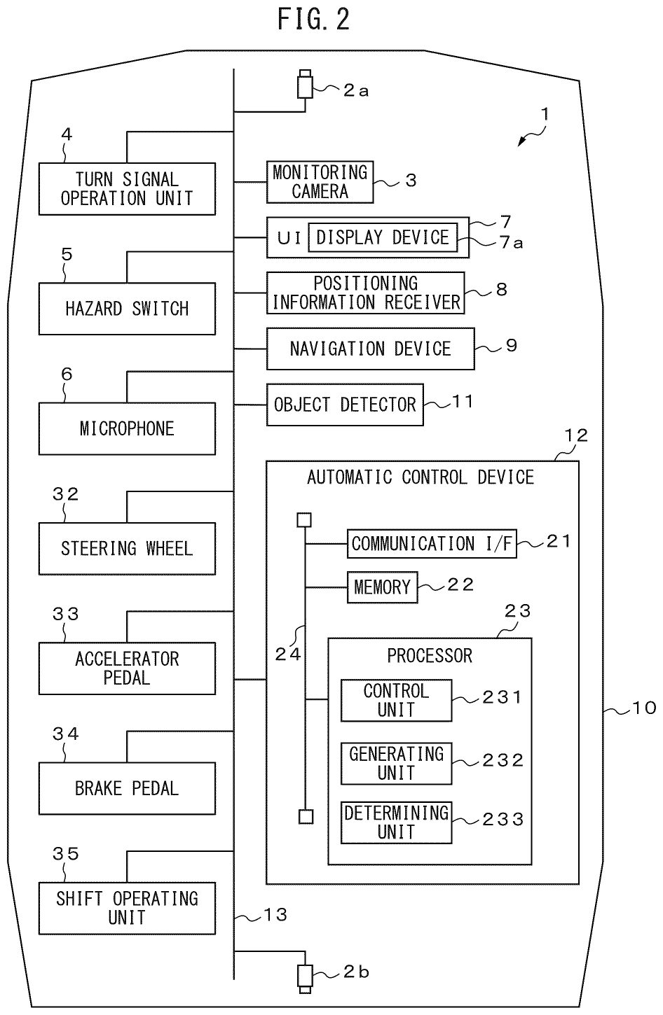

FIG. 2 is a hardware configuration diagram for a vehicle 10 in which the automatic control device 12 of the first embodiment is mounted. The vehicle 10 has a front camera 2a, a rear camera 2b, a monitoring camera 3, a turn signal operation unit 4, a hazard switch 5, a microphone 6, a user interface (UI) 7, a positioning information receiver 8, a navigation device 9, an automatic control device 12, a steering wheel 32, a brake pedal 33, an accelerator pedal 34 and a shift operating unit 35, etc. The vehicle 10 may also have a distance sensor such as a LiDAR sensor.

The front camera 2a, rear camera 2b, monitoring camera 3, turn signal operation unit 4, hazard switch 5, microphone 6, user interface (UI) 7, positioning information receiver 8, navigation device 9, automatic control device 12, steering wheel 32, brake pedal 33, accelerator pedal 34 and shift operating unit 35 are connected in a communicable manner via an in-vehicle network 13 that conforms to controller area network standards.

The front camera 2a and rear camera 2b are examples of image acquisition units provided in the vehicle 10. The front camera 2a is mounted inside the vehicle 10 and directed toward the front of the vehicle 10. The rear camera 2b is mounted inside the vehicle 10 and directed toward the rear of the vehicle 10.

The front camera 2a and rear camera 2b acquire camera images in which the environment of a region in a predetermined visual field ahead of and behind the vehicle 10 is shown, at a camera image acquisition time set with a predetermined cycle, for example. The camera image can show the road in the predetermined region ahead of and behind the vehicle 10, and road features such as road surface lane marking line.

The front camera 2a and rear camera 2b each have a 2D detector composed of an array of photoelectric conversion elements with visible light sensitivity, such as a CCD or C-MOS. The front camera 2a and rear camera 2b also each have an imaging optical system that forms an image of the image acquisition region on the 2D detector. The visual fields of the front camera 2a and rear camera 2b are examples of predetermined ranges around the vehicle 10.

Each time a camera image is acquired, the front camera 2a and rear camera 2b each output a camera image and the camera image acquisition time through the in-vehicle network 13 to the object detector 11. At the object detector 11, the camera images are used for processing to detect objects and road features surrounding the vehicle 10.

The monitoring camera 3 is disposed in the cabin 30 in a manner allowing it to acquire monitor images including the face of the driver 40 driving the vehicle 10. The monitoring camera 3 is disposed on the dashboard, for example.

The monitoring camera 3 is an example of an image acquisition unit. The monitoring camera 3 acquires a monitor image representing the surroundings of the driving seat 31 at a monitor image acquisition time having a predetermined cycle. The monitor image also includes the face of the driver 40 sitting in the driving seat 31.

The monitoring camera 3 has a 2D detector composed of an array of photoelectric conversion elements with infrared sensitivity, such as a CCD or C-MOS, and an imaging optical system that forms an image of the acquired region on the 2D detector.

Each time a monitor image is acquired, the monitoring camera 3 outputs the monitor image and the image acquisition time at which the monitor image was acquired, to the automatic control device 12 via the in-vehicle network 13. The monitor images are used by the automatic control device 12 to detect the orientation of the face of the driver 40.

The turn signal operation unit 4 is disposed on the steering column. The turn signal operation unit 4 inputs the direction of the lane change of the vehicle 10. The driver 40 indicates the direction of the lane change of the vehicle 10 by operating the turn signal operation unit 4 either upward or downward. The turn signal operation unit 4 outputs a turn signal operation signal representing the direction of the lane change of the vehicle 10, to the automatic control device 12 via the in-vehicle network 13. The turn signal operation signal is an example of operation information representing operation of the turn signal operation unit 4 by the driver 40. The turn signal operation signal is associated with lane changing of the vehicle 10.

The hazard switch 5 is an operating unit associated with emergency action of the vehicle 10. When operated by the driver 40, the hazard switch 5 outputs a hazard operation signal representing vehicle 10 emergency, to the automatic control device 12 via the in-vehicle network 13. The automatic control device 12 flashes a hazard lamp (not shown). The hazard operation signal is an example of operation information representing operation of the hazard switch 5 by the driver 40. The hazard operation signal is associated with emergency action of the vehicle 10.

The microphone 6 inputs acoustic sound from inside the cabin 30, and outputs an acoustic signal to the automatic control device 12 via the in-vehicle network 13. For example, the microphone 6 inputs the voice of the driver 40 and generates an acoustic signal.

The steering wheel 32 generates a steering signal corresponding to the steering angle created by the driver 40, and outputs it to the automatic control device 12 via the in-vehicle network 13. The steering signal is an example of operation information representing operation of the steering wheel 32 by the driver 40. The steering signal is associated with an action that changes the traveling direction of the vehicle 10.

The accelerator pedal 34 generates an accelerator signal corresponding to the accelerator level created by the driver, and outputs it to the automatic control device 12 via the in-vehicle network 13. The accelerator signal is an example of operation information representing operation of the accelerator pedal 34 by the driver 40. The accelerator signal is associated with action that accelerates the vehicle 10.

The brake pedal 33 generates a brake signal corresponding to the brake level created by the driver, and outputs it to the automatic control device 12 via the in-vehicle network 13. The brake signal is an example of operation information representing operation of the brake pedal 33 by the driver 40. The brake signal is associated with action that brakes the vehicle 10.

The shift operating unit 35 generates a shift signal corresponding to the shift position by driver operation, and outputs it to the automatic control device 12 via the in-vehicle network 13. The shift signal is an example of operation information representing operation of the shift operating unit 35 by the driver 40. The shift signal is associated with gear shift action of the vehicle 10.

The UI 7 is an example of the notification unit. The UI 7, controlled by the automatic control device 12, notifies the driver 40 of information relating to the vehicle 10. The UI 7 has a display device 7a such as a liquid crystal display or touch panel, for display of the information. The UI 7 may also have an acoustic output device (not shown) to relay the information to the driver 40. The UI 7 also has a touch panel or operating button, for example, as an input device for inputting operation information from the driver 40 to the vehicle 10. The UI 7 outputs the input information to the automatic control device 12, etc. via the in-vehicle network 13.

The positioning information receiver 8 outputs positioning information that represents the current location of the vehicle 10. The positioning information receiver 8 may be a GNSS receiver, for example. The positioning information receiver 8 outputs positioning information and the positioning information acquisition time at which the positioning information has been acquired, to the navigation device 9, each time positioning information is acquired at a predetermined receiving cycle.

Based on the navigation map information, the destination location of the vehicle 10 input through the UI 7, and positioning information representing the current location of the vehicle 10 input from the positioning information receiver 8, the navigation device 9 creates a navigation route from the current location to the destination location of the vehicle 10. The navigation route includes information relating to the locations of right turns, left turns, mergings and branchings. When the destination location has been newly set or the current location of the vehicle 10 has exited the navigation route, the navigation device 9 creates a new navigation route for the vehicle 10. Every time a navigation route is created, the navigation device 9 outputs the navigation route to the automatic control device 12, for example, via the in-vehicle network 13.

The object detector 11 detects objects around the vehicle 10 and their types (for example, vehicles) based on camera images. Such objects include other vehicles traveling around the vehicle 10. The object detector 11 has a classifier that detects objects represented in the camera images, by input of the camera images. As the classifier, the object detector 11 may use a deep neural network (DNN), for example, that has been trained to detect objects represented in camera images, from the camera images that have been input, for example. The classifier is preferably able to distinguish large vehicles from smaller vehicles.

The object detector 11 estimates the locations of objects based on the locations of the objects in the camera images, internal parameters including the focal lengths of the front camera 2a and rear camera 2b, and the external parameters including the installed locations and orientations of the front camera 2a and rear camera 2b. When a distance sensor such as a LiDAR sensor is disposed in the vehicle 10, the object detector 11 may estimate the locations of objects using measurement results from the distance sensor in tandem with the camera images.

The object detector 11 identifies the traveling lanes in which the objects are traveling, based on the lane marking lines represented in the map information and the locations of the objects. The object detector 11 also outputs object detection information which includes the types of objects that were detected, their locations, and traveling lanes, to the automatic control device 12. The object detection information is an example of environment information.

The automatic control device 12 carries out control processing, generation processing and determination processing. For this purpose, the automatic control device 12 has a communication interface (IF) 21, a memory 22 and a processor 23. The communication interface 21, memory 22 and processor 23 are connected via signal wires 24. The communication interface 21 has an interface circuit to connect the automatic control device 12 with the in-vehicle network 13.

The memory 22 is an example of a storage unit, and it has a volatile semiconductor memory and a non-volatile semiconductor memory, for example. The memory 22 stores an application computer program and various data to be used for information processing carried out by the processor 23 of each device.

All or some of the functions of the automatic control device 12 are carried out by functional modules driven by a computer program operating on the processor 23, for example. The processor 23 has a control unit 231, a generating unit 232 and a determining unit 233. Alternatively, the functional module of the processor 23 may be a specialized computing circuit in the processor 23. The processor 23 has one or more CPUs (Central Processing Units) and their peripheral circuits. The processor 23 may also have other computing circuits such as a logical operation unit, numerical calculation unit or graphics processing unit.

The object detector 11 and automatic control device 12 are electronic control units (ECU), for example. For FIG. 2, the object detector 11 and automatic control device 12 were described as separate devices (for example, the Electronic Control Unit: ECU), but these devices may also be constructed as a single device. The processor 23 includes the control unit 231, generating unit 232 and determining unit 233, but the control unit 231, generating unit 232 and determining unit 233 may also be included in separate processors.

The control unit 231 controls actions of the vehicle 10. The control unit 231 has a self-driving mode (autonomous mode) in which the vehicle 10 is driven by automatic control, and a manual driving mode in which operation of the vehicle 10 is controlled based on manipulation by the driver 40. In self-driving mode, the vehicle 10 is driven primarily by the control unit 231. In self-driving mode, the control unit 231 controls operations such as steering, actuation and braking, based on the current location of the vehicle 10, map information and on camera images from the front camera 2a and rear camera 2b mounted on the vehicle 10.

In manual driving mode, the control unit 231 controls operation of the vehicle 10 including steering, actuation and braking based on manipulation by the driver 40. In manual driving mode, the vehicle 10 is driven primarily by the driver 40. In manual driving mode, the control unit 231 controls operation of the vehicle 10 based on operation of at least one from among the steering wheel 32, brake pedal 33 and accelerator pedal 34 by the driver 40.

Even in self-driving mode, the driver 40 is still able to partially control the vehicle 10. For example, in self-driving mode the driver 40 can make a lane change by operating the steering wheel 3. Operation by the driver 40 overrides operation by the automatic control device 12.

Likewise even in manual driving mode, the automatic control device 12 is still able to partially control the vehicle 10. For example, in manual driving mode the automatic control device 12 makes lane changes in response to requests by the driver 40.

The generating unit 232 generates action information representing a predetermined driver action by the driver 40. The action information includes driver 40 operation of operating units different from those associated with predetermined vehicle actions for the vehicle 10, as well as the orientation of the face of the driver 40 in a predetermined direction and driver 40 vocalization. When the vehicle action is a lane change, the action information refers to driver 40 operation of operating units different from the turn signal operation unit 4. The generating unit 232 relays the action information to the determining unit 233.

When the generating unit 232 has input a turn signal operation signal, the generating unit 232 generates action information representing driver 40 operation of the turn signal operation unit 4. When the generating unit 232 has input a hazard operation signal, the generating unit 232 generates action information representing driver 40 operation of the hazard switch 5. When the generating unit 232 has input a steering signal, the generating unit 232 generates action information representing driver 40 operation of the steering wheel 32. When the generating unit 232 has input an accelerator signal, the generating unit 232 generates action information representing driver 40 operation of the accelerator pedal 34. When the generating unit 232 has input a brake signal, the generating unit 232 generates action information representing driver 40 operation of the brake pedal 33. When the generating unit 232 has input a shift signal, the generating unit 232 generates action information representing driver 40 operation of the shift operating unit 35.

The generating unit 232 estimates the orientation of the face of the driver 40 based on monitor images. The angle representing the facial orientation is represented as an angle in the horizontal direction between the traveling direction of the vehicle 10 and the direction in which the face of the driver 40 is facing. The generating unit 232 identifies the locations of predetermined parts of the face such as the eye corners, inner eyes or mouth corner points in acquired monitor images, by inputting the monitor images into a classifier trained to detect those predetermined parts of the face. The generating unit 232 also compares the locations of the predetermined facial aspects detected from the monitor image against a standard facial three-dimensional model. The face angle in a three-dimensional model in which the location of each facial aspect maximally matches the aspect location detected from the monitor image is detected as the face angle in the monitor image.

The classifier may be a convoluted deep neural network (DNN) having multiple layers connected in series from the input end to the output end, for example. The DNN that has been trained using facial images, including predetermined facial aspects, as teacher data, functions as a classifier to identify the locations of predetermined facial aspects.

The generating unit 232 then determines the locations of the pupil centers and eye centers based on the location of the eye corners or inner eyes, and estimates the direction of the line of sight of the driver 40 to be the direction connecting the locations of the eye centers and pupil centers. The generating unit 232 generates an angle in the horizontal direction representing the facial orientation, as action information.

When an acoustic signal has been input through the microphone 6, the generating unit 232 inputs the acoustic signal into a classifier which has been trained to identify human voices. When the acoustic signal has been identified as including a human voice, the generating unit 232 generates action information indicating that the driver 40 has spoken.

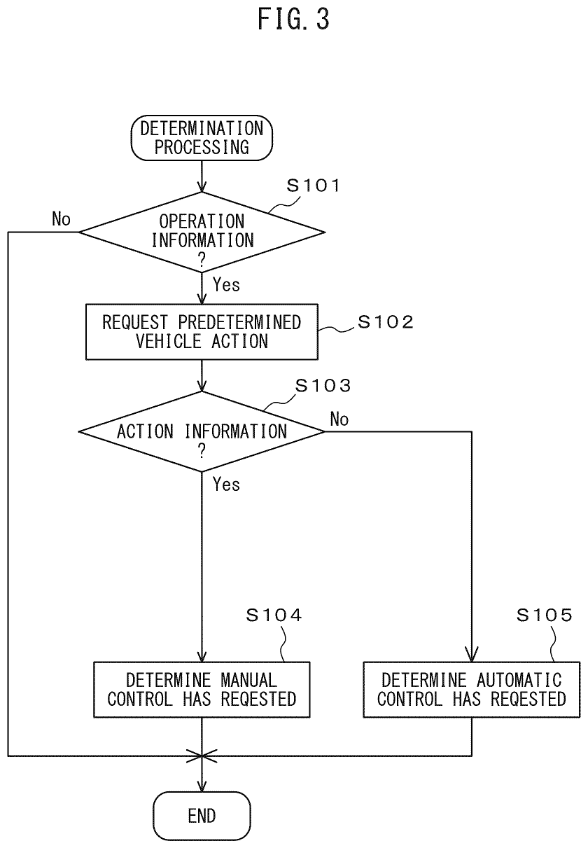

FIG. 3 is an example of an operation flow chart for determination processing by the automatic control device 12 of the first embodiment. For this embodiment, the determining unit 233 carries out determination based on operation information and action information. When the automatic control device 12 is in self-driving mode, the automatic control device 12 carries out determination processing according to the operation flow chart shown in FIG. 3, at a determining time having a predetermined cycle. The cycle for the determining time may be from 0.1 to 0.5 seconds, for example. The automatic control device 12 may carry out determination processing even when the automatic control device 12 is in manual driving mode.

The determining unit 233 first determines whether or not operation information has been input into the predetermined operating unit (step S101). The operation information represents driver 40 operation of the predetermined operating unit associated with the vehicle action determined by the determining unit 233. The vehicle action includes, for example, lane changes, vehicle stopping, parking, changes in traveling direction, acceleration and deceleration.

When operation information has been input (step S101—Yes), the determining unit 233 determines that the driver 40 has requested a predetermined vehicle action (step S102). The vehicle action is thereby associated with the operation information.

Next, the determining unit 233 determines whether or not action information representing the predetermined driver action by the driver 40 has been input (step S103). The action information includes driver operation of operating units different from the operating unit associated with the vehicle action, orientation of the face of the driver in a predetermined direction, and driver vocalization. Predetermined operating units different from the operating unit associated with the vehicle action include the hazard switch 5, for example.

When action information has been input (step S103—Yes), the determining unit 233 determines that the driver 40 has requested to carry out the vehicle action by manual control (step S104), and the series of processing steps is complete.

When action information has not been input (step S103—No), on the other hand, the determining unit 233 determines that the driver 40 has requested to carry out the vehicle action by automatic control (step S105), and the series of processing steps is complete. When operation information has not been input (step S101—No), the series of processing steps is likewise complete. The determination processing described above will now be explained using a specific vehicle action.

(1) Determination processing where the vehicle action is a lane change. The operation information is a turn signal operation signal representing operation of the turn signal operation unit 4 by the driver 40. The turn signal operation signal is associated with lane change of the vehicle 10. When a turn signal operation signal has been input, the determining unit 233 determines that the driver 40 has requested a lane change for the vehicle 10. The action information is the orientation of the face of the driver 40 matching the direction of the lane change of the vehicle 10 represented by the operation information.

The action information representing the predetermined driver action by the driver 40 is the orientation of the face of the driver 40 that matches the direction of the lane change of the vehicle 10 represented by the turn signal operation signal. The determining unit 233 determines whether or not the angle representing the orientation of the face of the driver 40 represented by the action information matches the direction of the lane change of the vehicle 10 represented by the turn signal operation signal. When the direction of the lane change of the vehicle 10 represented by the turn signal operation signal matches the orientation of the face of the driver, the determining unit 233 determines that the driver 40 has requested to carry out the lane change by manual control.

When the direction of the lane change of the vehicle 10 represented by the turn signal operation signal is toward the right, and the angle representing the orientation of the face of the driver 40 is within a range of 30° to 90° clockwise with respect to the traveling direction of the vehicle 10, then the orientation of the face of the driver matches the direction of the lane change. When the direction of the lane change of the vehicle 10 represented by the turn signal operation signal is toward the left, and the angle representing the orientation of the face of the driver 40 is within a range of 30° to 90° counterclockwise with respect to the traveling direction of the vehicle 10, then the orientation of the face of the driver matches the direction of the lane change.

If the driver 40 is looking in the direction in which the vehicle 10 is to move when the turn signal operation unit 4 has been operated, this indicates that the driver 40 is actively confirming the situation in the direction in which the vehicle 10 is to move. It is likely that the driver 40 intends to make the lane change by their own operation of the vehicle 10.

The automatic control device 12 flashes a direction indicator (not shown) depending on indication of the direction of the lane change of the vehicle 10, but the automatic control device 12 controls action of the vehicle 10 for lane changing of the vehicle 10 based on operation by the driver 40.

When the direction of the lane change of the vehicle 10 represented by the turn signal operation signal does not match the orientation of the face of the driver, the determining unit 233 determines that the driver 40 has requested to carry out the lane change by automatic control.

If the driver 40 is not looking in the direction in which the vehicle 10 is to move when the turn signal operation unit 4 has been operated, this indicates that the driver 40 is not actively confirming the situation in the direction in which the vehicle 10 is to move. It is likely that the driver 40 does not intend to make the lane change by their own operation of the vehicle 10.

The automatic control device 12 flashes a direction indicator (not shown) depending on indication of the direction of the lane change of the vehicle 10, and controls action of the vehicle 10 for lane changing of the vehicle 10.

The action information does not need to be the orientation of the face of the driver 40. For example, the action information may be driver 40 operation of an operating unit different from the turn signal operation unit 4, orientation of the face of the driver 40 in a predetermined direction, or driver 40 vocalization.

(2) Determination processing where the vehicle action is parking in a parking space, for a vehicle 10 in a parking lot. The determining unit 233 determines that the vehicle 10 is in a parking lot, based on the current location of the vehicle 10 and map information. The operation information is a shift operation signal representing driver 40 operation of the shift operating unit 35 for shifting the shift position to the reverse position. When the vehicle 10 is in a parking lot, the shift operation signal representing the reverse position is associated with the action of parking the vehicle 10 in the parking space. When a shift operation signal representing the reverse position has been input, the determining unit 233 determines that the driver 40 has requested to park the vehicle 10 in the parking space.

The action information representing the predetermined driver action by the driver 40 is an operation signal representing operation of the hazard switch 5 by the driver 40. When a shift operation signal representing the reverse position has been input and action information representing driver 40 operation of the hazard switch 5 has been input, the determining unit 233 determines that the driver 40 has requested to carry out a parking action of the vehicle 10 in the parking space by manual control.

Operation of the shift operating unit 35 to the reverse position and operation of the hazard switch 5 by the driver 40 indicates that the driver 40 is carrying out parking of the vehicle 10 in the parking space by manual control. The automatic control device 12 controls the action of the vehicle 10 based on operation by the driver 40.

When a shift operation signal representing the reverse position has been input and action information representing driver 40 operation of the hazard switch 5 has not been input, on the other hand, the determining unit 233 determines that the driver 40 has requested to carry out parking of the vehicle 10 in the parking space by automatic control.

Lack of operation of another operating unit by the driver 40, for example, when the shift operating unit 35 has been moved to the reverse position indicates that the driver 40 does not intend to carry out parking of the vehicle 10 in the parking space by manual control. The automatic control device 12 carries out parking of the vehicle 10 into the parking space.

Since as explained above, the automatic control device of the embodiment determines whether the driver has requested to carry out automatic control for vehicle action or whether the driver has requested to carry out manual control for vehicle action based on predetermined other information in addition to operation information, burden on the driver can be reduced.

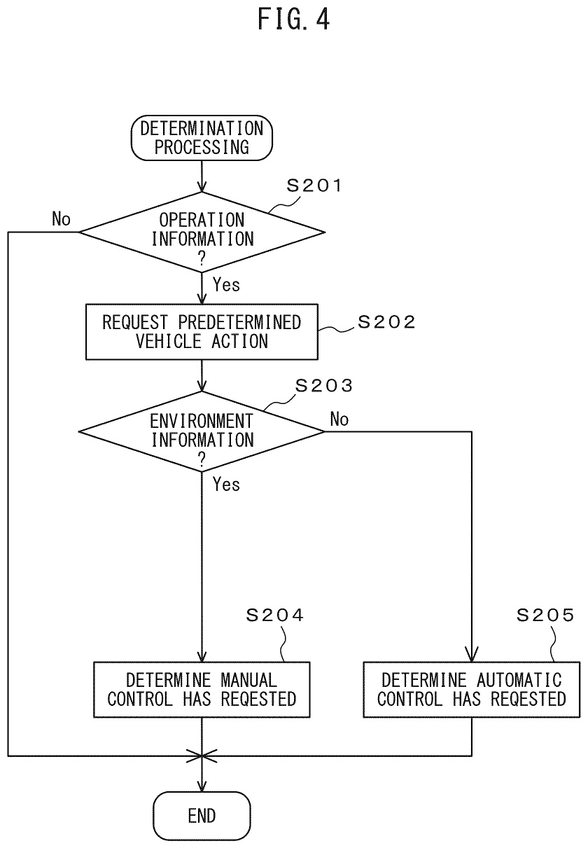

Another embodiment of the automatic control device 12 will now be described with reference to FIG. 4 to FIG. 7. The detailed explanation provided for the first embodiment applies for any aspects of this additional embodiment that are not explained here.

FIG. 4 is an example of an operation flow chart for determination processing by the automatic control device 12 of the second embodiment. For this embodiment, the determining unit 233 carries out determination based on operation information and environment information.

Step S203 in the operation flow chart shown in FIG. 4 differs from step S103 described above. The processing in steps S201, S202, S204 and S205 is the same as the processing in steps S101, S102, S104 and S105.

The determining unit 233 first determines whether or not predetermined operation information has been input (step S201).

When operation information has been input (step S201—Yes), the determining unit 233 determines that the driver 40 has requested a predetermined vehicle action (step S202).

Next, the determining unit 233 determines whether or not environment information representing the predetermined environment around the vehicle 10 has been input (step S203).

When environment information has been input (step S203—Yes), the determining unit 233 determines that the driver 40 has requested to carry out the vehicle action by manual control (step S204), and the series of processing steps is complete. The environment information represents, for example, other vehicle locations.

When environment information has not been input (step S203—No), on the other hand, the determining unit 233 determines that the driver 40 has requested to carry out the vehicle action by automatic control (step S205), and the series of processing steps is complete. When operation information has not been input (step S201—No), the series of processing steps is likewise complete. The determination processing described above will now be explained using a specific vehicle action.

(1) Determination processing where the vehicle action is a lane change. The operation information is a turn signal operation signal representing operation of the turn signal operation unit 4 by the driver. The turn signal operation signal is associated with lane change of the vehicle 10. When a turn signal operation signal has been input, the determining unit 233 determines that the driver 40 has requested a lane change for the vehicle 10. The environment information represents the locations of other vehicles around the vehicle 10. The area around the vehicle 10 corresponds to the detection ranges of the front camera 2a and rear camera 2b.

The environment information representing the predetermined environment around the vehicle 10 is the location of another vehicle in the direction of the lane change of the vehicle 10 indicated by the turn signal operation signal. The determining unit 233 determines whether or not another vehicle is located in the direction of the lane change of the vehicle 10 represented by the turn signal operation signal, based on object detection information as environment information. When another vehicle is located in the direction of the lane change of the vehicle 10 represented by the turn signal operation signal, the determining unit 233 determines that the driver 40 has requested to carry out the lane change by manual control.

When another vehicle is not present in the direction in which the driver 40 is to move the vehicle 10 at the time the turn signal operation unit 4 has been operated, then it is likely that the driver 40 intends to make the lane change by their own operation of the vehicle 10.

The automatic control device 12 flashes a direction indicator (not shown) depending on indication of the direction of the lane change of the vehicle 10, but the automatic control device 12 controls action of the vehicle 10 for lane changing of the vehicle 10 based on operation by the driver 40.

When another vehicle is located in the direction of the lane change of the vehicle 10 represented by the turn signal operation signal, on the other hand, the determining unit 233 determines that the driver 40 has requested to carry out the lane change by automatic control.

When another vehicle is present in the direction in which the driver 40 is to move the vehicle 10 at the time the turn signal operation unit 4 has been operated, then it is likely that the driver 40 does not intend to make the lane change by their own operation of the vehicle 10.

The automatic control device 12 flashes a direction indicator (not shown) depending on indication of the direction of the lane change of the vehicle 10, and controls action of the vehicle 10 for lane changing of the vehicle 10.

(2) Determination processing where the vehicle action is an emergency action. The operation information is a hazard operation signal representing operation of the hazard switch 5 by the driver. The hazard operation signal is associated with emergency action of the vehicle 10. When a hazard operation signal has been input, the determining unit 233 determines that the driver 40 has requested an emergency action of the vehicle 10. The emergency action of the vehicle 10 is deceleration to a stop.

The environment information representing the predetermined environment around the vehicle 10 is information indicating that the area around the vehicle 10 is not congested. When the object detection information indicates that the number of vehicles around the vehicle 10 is equal to or less than a reference number, the determining unit 233 determines that the area around the vehicle 10 is not congested.

When the area around the vehicle 10 is not congested, the determining unit 233 determines that the driver 40 has requested to carry out an emergency action of the vehicle 10 by manual control.

If the area around the vehicle 10 is not congested when the hazard switch 5 has been operated, it is likely that the driver 40 intends to decelerate to a stop by their own operation of the vehicle 10. The automatic control device 12 flashes the hazard lamp (not shown), and action of the vehicle 10 is controlled based on operation by the driver 40.

When the area around the vehicle 10 is congested, on the other hand, the determining unit 233 determines that the driver 40 has requested to carry out an emergency action of the vehicle 10 by automatic control.

If the area around the vehicle 10 is congested when the hazard switch 5 has been operated, it is likely that the driver 40 does not intend to decelerate to a stop by their own operation of the vehicle 10. The automatic control device 12 flashes the hazard lamp (not shown), and action of the vehicle 10 is controlled so as to decelerate the vehicle 10 to a stop.

(3) Determination processing where the vehicle action is a change in traveling location during a lane tracing action. In a lane tracing action, the control unit 231 controls the vehicle 10 so that the vehicle 10 travels along the center of a traffic lane. The operation information is a steering operation signal representing operation of the steering wheel 32 by the driver. The steering operation signal indicating that the steering wheel 32 has been steered toward the left or toward the right and then returned to the center during a lane tracing action, represents a change in traveling location of the vehicle 10. When a steering operation signal has been input that indicates that the steering wheel 32 has been steered toward the left or toward the right and then returned to the center, the determining unit 233 determines that the driver 40 has requested a change in traveling location of the vehicle 10.

The environment information representing the predetermined environment around the vehicle 10 is information indicating that no large vehicles are traveling beside the vehicle 10. The determining unit 233 determines whether or not a large vehicle is traveling beside the vehicle 10 based on object detection information, as environment information.

When the object detection information indicates that a large vehicle is not traveling beside the vehicle 10, the determining unit 233 determines that the driver 40 has requested to carry out a change in traveling location of the vehicle 10 by manual control.

The automatic control device 12 controls the change in traveling location of the vehicle 10 based on operation of the steering wheel 32 by the driver 40.

When the object detection information indicates that a large vehicle is traveling beside the vehicle 10, the determining unit 233 determines that the driver 40 has requested to carry out a change in traveling location of the vehicle 10 by automatic control.

The automatic control device 12 changes the traveling location of the vehicle 10 only by a predetermined distance from the center of the traffic lane in a direction away from the large vehicle traveling beside the vehicle 10.

The automatic control device of this embodiment also exhibits the same effect as the first embodiment.

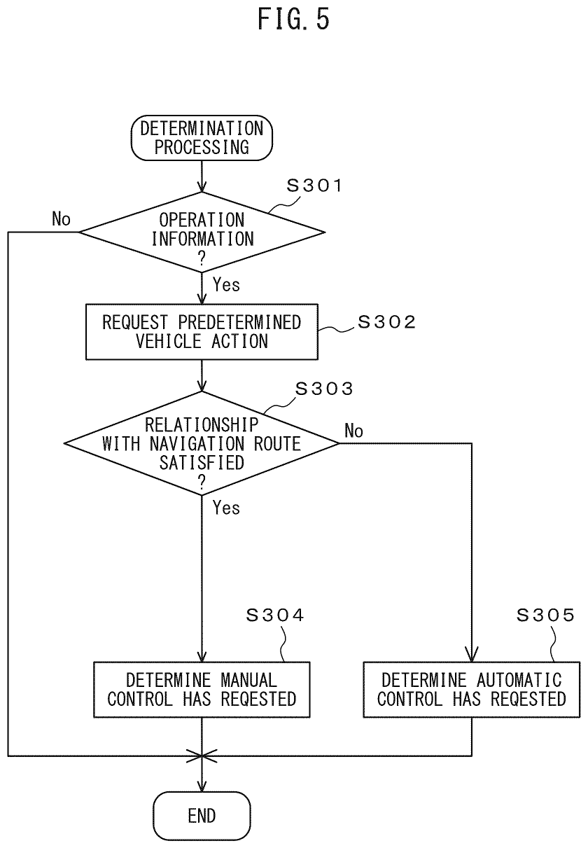

FIG. 5 is an example of an operation flow chart for determination processing by the automatic control device of the third embodiment. For this embodiment, the determining unit 233 carries out determination based on operation information and the navigation route of the vehicle 10.

Step S303 in the operation flow chart shown in FIG. 4 differs from step S103 described above. The processing in steps S301, S302, S304 and S305 is the same as the processing in steps S101, S102, S104 and S105.

The determining unit 233 first determines whether or not predetermined operation information has been input (step S301).

When operation information has been input (step S301—Yes), the determining unit 233 determines that the driver 40 has requested a predetermined vehicle action (step S302).

Next, the determining unit 233 determines whether or not the relationship between the vehicle action represented by the operation information, and the navigation route, satisfies a predetermined relationship (step S303).

When the predetermined relationship is satisfied (step S303—Yes), the determining unit 233 determines that the driver 40 has requested to carry out the vehicle action by manual control (step S304), and the series of processing steps is complete.

When the predetermined relationship is not satisfied (step S303—No), the determining unit 233 determines that the driver 40 has requested to carry out the vehicle action by automatic control (step S305), and the series of processing steps is complete. When operation information has not been input (step S101—No), the series of processing steps is likewise complete. The determination processing described above will now be explained using a specific vehicle action.

Determination processing where the vehicle action is a lane change. The operation information is a turn signal operation signal representing operation of the turn signal operation unit 4 by the driver. The turn signal operation signal is associated with lane change of the vehicle 10. When a turn signal operation signal has been input, the determining unit 233 determines that the driver 40 has requested a lane change for the vehicle 10.

The determining unit 233 determines whether or not the direction of the lane change of the vehicle 10 represented by the turn signal operation signal differs from the traveling direction of the vehicle 10 toward the destination location of the vehicle 10 represented in the navigation route.

For example, when the turn signal operation signal indicates a lane change of the vehicle 10 toward the right and the navigation route indicates that the vehicle 10 is to make a left turn at an intersection ahead, then the determining unit 233 determines that they are different.

When they are different, the determining unit 233 determines that the driver 40 has requested to carry out a lane change by manual control.

If the direction of the lane change of the vehicle 10 represented by the turn signal operation signal differs from the traveling direction of the vehicle 10 toward the destination location of the vehicle 10 as represented in the navigation route, it is likely that the driver 40 intends to make a lane change by their own operation of the vehicle 10.

The automatic control device 12 flashes a direction indicator (not shown) depending on indication of the direction of the lane change of the vehicle 10, but the automatic control device 12 controls action of the vehicle 10 for lane changing of the vehicle 10 based on operation by the driver 40.

When they are not different, on the other hand, the determining unit 233 determines that the driver 40 has requested to carry out the lane change by automatic control.

If the direction of the lane change of the vehicle 10 represented by the turn signal operation signal is the same as the traveling direction of the vehicle 10 toward the destination location of the vehicle 10 as represented in the navigation route, it is likely that the driver 40 does not intend to make a lane change by their own operation of the vehicle 10.

The automatic control device 12 flashes a direction indicator (not shown) depending on indication of the direction of the lane change of the vehicle 10, and controls action of the vehicle 10 for lane changing of the vehicle 10.

The automatic control device of this embodiment also exhibits the same effect as the first embodiment.

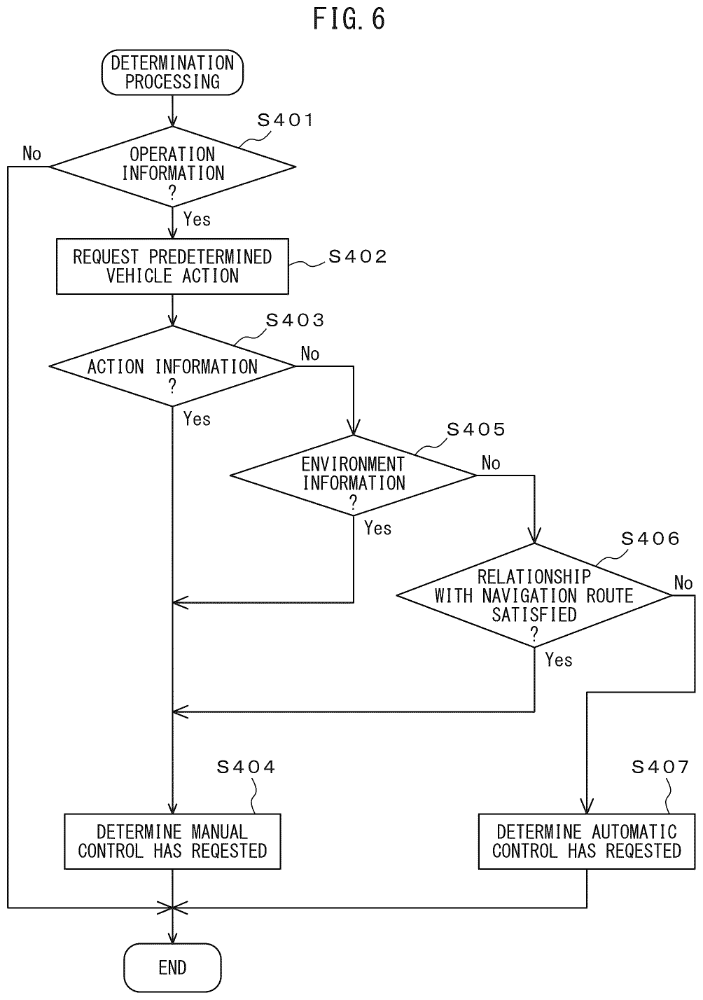

FIG. 6 is an example of an operation flow chart for determination processing by the automatic control device of the fourth embodiment. For this embodiment, the determining unit 233 carries out determination based on operation information, action information, environment information, and the navigation route of the vehicle 10.

The operation flow chart shown in FIG. 6 differs from the operation flow chart shown in FIG. 3 in that the processing in steps S405 and S406 have been added. The processing in steps S401 to S404 and S407 is the same as in steps S101 to S105 described above.

The determining unit 233 first determines whether or not predetermined operation information has been input (step S401).

When operation information has been input (step S401—Yes), the determining unit 233 determines that the driver 40 has requested a predetermined vehicle action (step S402).

Next, the determining unit 233 determines whether or not action information representing the predetermined driver action by the driver has been input (step S403).

When action information has been input (step S403—Yes), the determining unit 233 determines that the driver 40 has requested to carry out the vehicle action by manual control (step S404), and the series of processing steps is complete.

When action information has not been input (step S403—No), on the other hand, the determining unit 233 determines whether or not environment information representing the predetermined environment around the vehicle 10 has been input (step S405).

When environment information has been input (step S405—Yes), the determining unit 233 determines that the driver 40 has requested to carry out the vehicle action by manual control (step S404), and the series of processing steps is complete.

When environment information has not been input (step S405—No), on the other hand, it is determined whether or not the relationship with the navigation route satisfies the predetermined relationship (step S406).

When predetermined relationship is satisfied (step S406—Yes), the determining unit 233 determines that the driver 40 has requested to carry out the vehicle action by manual control (step S404), and the series of processing steps is complete.

When predetermined relationship is not satisfied (step S406—No), the determining unit 233 determines that the driver 40 has requested to carry out the vehicle action by automatic control (step S407), and the series of processing steps is complete. When operation information has not been input (step S401—No), the series of processing steps is likewise complete.

Since the determining unit of the automatic control device of this embodiment described above thus carries out determination based on operation information, action information, environment information and the vehicle 10 navigation route, it helps to reduce burden on the driver. The automatic control device of this embodiment also exhibits the same effect as the first embodiment.

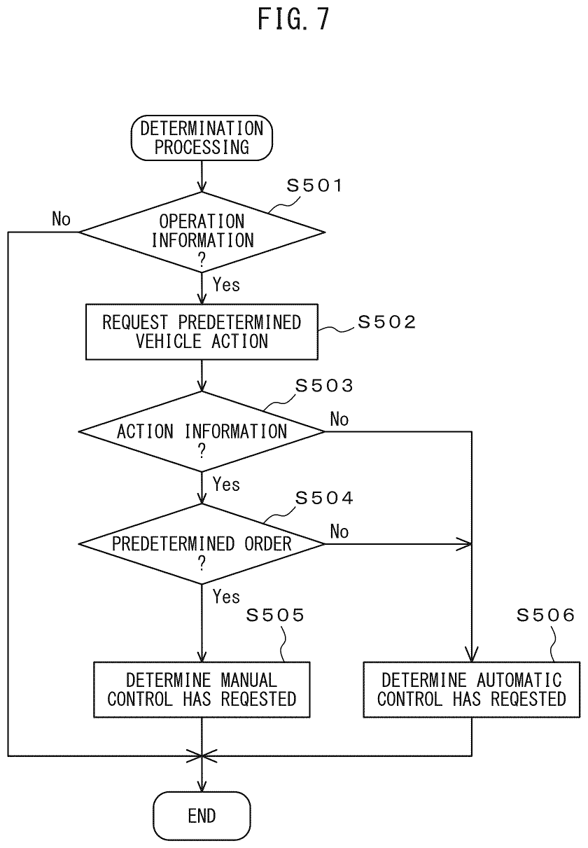

FIG. 7 is an example of an operation flow chart for determination processing by the automatic control device of the fifth embodiment. According to this embodiment, the determining unit 233 carries out determination based on the order of generation of the operation information and generation of the action information.

The determining unit 233 first determines whether or not predetermined operation information has been input (step S501).

When operation information has been input (step S501—Yes), the determining unit 233 determines that the driver 40 has requested a predetermined vehicle action (step S502).

Next, the determining unit 233 determines whether or not action information representing the predetermined driver action by the driver has been input (step S503).

When action information has been input (step S503—Yes), the determining unit 233 determines whether or not the order of generation of the operation information and generation of the action information is in the predetermined order (step S504). The determining unit 233 may also consider a first time point at which the operation information was input to the automatic control device 12 to be the time at which the operation information was generated. The determining unit 233 may also consider a second time point at which the action information was relayed to the determining unit 233 to be the time at which the action information was generated.

The order of generation of the operation information and generation of the action information may include the cases in which the second time point and the first time point are the same, the second time point is before the first time point, or the second time point is after the first time point.

The second time point and first time point are determined to be the same if the difference between the second time point and first time point is within a predetermined reference time. The second time point is determined to be before the first time point if the second time point is beyond a reference time before the first time point. The second time point is determined to be after the first time point if the second time point is beyond a reference time after the first time point.

For example, when the second time point and first time point are the same, the determining unit 233 determines that generation of the operation information and generation of the action information are in the predetermined order. When the second time point is before the first time point or the second time point is after the first time point, on the other hand, the determining unit 233 determines that generation of the operation information and generation of the action information are not in the predetermined order.

When the second time point is before the first time point, the determining unit 233 may still determine that generation of the operation information and generation of the action information are in the predetermined order. Alternatively, when the second time point and the first time point are the same, or the second time point is after the first time point, the determining unit 233 may determine that generation of the operation information and generation of the action information are not in the predetermined order.

Also, when the second time point is after the first time point, the determining unit 233 may determine that generation of the operation information and generation of the action information are in the predetermined order. When the second time point is before the first time point, or the second time point and the first time point are the same, the determining unit 233 may determine that generation of the operation information and generation of the action information are not in the predetermined order.

When the generation of the operation information and generation of the action information are in the predetermined order (step S504—Yes), the determining unit 233 determines that the driver 40 has requested to carry out the vehicle action by manual control (step S505), and the series of processing steps is complete.

When action information has not been input (step S503—No), or generation of the operation information and generation of the action information are not in the predetermined order (step S504—No), the determining unit 233 determines that the driver 40 has requested to carry out the vehicle action by automatic control (step S506), and the series of processing steps is complete. When operation information has not been input (step S501—No), the series of processing steps is likewise complete. The determination processing described above will now be explained using a specific vehicle action.

(1) The operation information is a turn signal operation signal representing operation of the turn signal operation unit 4 by the driver. The turn signal operation signal is associated with lane change of the vehicle 10. When a turn signal operation signal has been input, the determining unit 233 determines that the driver 40 has requested a lane change for the vehicle 10. The predetermined action information is action information representing operation of the hazard switch 5 by the driver 40.

When the first time point at which the turn signal operation signal was input into the automatic control device 12 is the same as the second time point at which the action information representing operation of the hazard switch 5 by the driver 40 was relayed to the determining unit 233, the determining unit 233 determines that generation of the operation information and generation of the action information are in the predetermined order.

When the second time point is before the first time point or the second time point is after the first time point, on the other hand, the determining unit 233 determines that generation of the operation information and generation of the action information are not in the predetermined order.

(2) The operation information is a turn signal operation signal representing operation of the turn signal operation unit 4 by the driver. The turn signal operation signal is associated with lane changing of the vehicle 10. When a turn signal operation signal has been input, the determining unit 233 determines that the driver 40 has requested a lane change for the vehicle 10. The predetermined action information is the orientation of the face of the driver 40 matching the direction of the lane change of the vehicle 10 represented by the operation information.

When the first time point at which the turn signal operation signal was input into the automatic control device 12 is the same as the second time point at which action information, indicating that the orientation of the face of the driver 40 matches the direction of the lane change of the vehicle 10 represented by the turn signal operation signal, was relayed to the determining unit 233, the determining unit 233 determines that generation of the operation information and generation of the action information are in the predetermined order.

When the second time point is before the first time point or the second time point is after the first time point, on the other hand, the determining unit 233 determines that generation of the operation information and generation of the action information are not in the predetermined order.

With the automatic control device of the fifth embodiment described in detail above, it can be relayed either that a driver has requested to carry out automatic control or that the driver has requested to carry out manual control, for a predetermined operation of the vehicle, simply by the driver carrying out driver action at a predetermined timing for operation of a predetermined operating unit. This embodiment also exhibits the same effect as the first embodiment.

The determining device, computer program for determination and determining method according to the embodiments described in the present disclosure may incorporate appropriate modifications that still fall within the gist of the disclosure. Moreover, the technical scope of the disclosure is not limited to these embodiments, and includes the invention and its equivalents as laid out in the Claims.

For example, the operation information, action information and environment information of the embodiments described above are merely examples and are not intended to be limitative. Moreover the method by which the determining unit carries out determination based on one or more of the operation information, action information, environment information and the navigation route is merely an example and is not intended to be limitative.

For example, the determining unit may determine an acceleration action based on an accelerator signal as operation information, and one or more from among action information, environment information and the navigation route. The determining unit may also determine a braking action based on a brake signal as operation information, and one or more from among action information, environment information and the navigation route.

The relationship between the determination results for a predetermined operation information and predetermined action information may also be used for training of the automatic control device while the driver is driving the vehicle.

1. A determining device comprising:
a processor configured to
determine whether a driver has requested to carry out automatic control for a vehicle action associated with operation information or the driver has requested to carry out manual control for the vehicle action, based on the operation information representing operation of a first operating device by the driver, and one or more from among action information representing a predetermined driver action by the driver, environment information representing a predetermined environment around the vehicle and a vehicle navigation route.

2. The determining device according to claim 1, wherein the action information comprises driver operation of a second operating device different from the first operating device, orientation of a face of the driver in a predetermined direction, and driver vocalization.

3. The determining device according to claim 1, wherein the processor is further configured to determine whether the driver has requested to carry out automatic control of the vehicle action or the driver has requested to carry out manual control of the vehicle action, based on order of generation of the operation information and generation of the action information.

4. The determining device according to claim 1, wherein
the first operating device is a turn signal operation device that inputs a direction of a lane change by the vehicle and the vehicle action is the lane change associated with the turn signal operation device, and
the processor is further configured to determine that the driver has requested to carry out manual control of the vehicle action when the direction of the lane change of the vehicle represented by the operation information matches the orientation of the face of the driver represented by the action information.

5. The determining device according to claim 1, wherein the environment information represents another vehicle around the vehicle.

6. The determining device according to claim 5, wherein
the first operating device is a turn signal operation device that inputs a direction of a lane change by the vehicle and the vehicle action is the lane change associated with the turn signal operation device, and
the processor is further configured to determine that the driver has requested to carry out automatic control of the vehicle action when the environment information shows that another vehicle is located in the direction of the lane change of the vehicle represented by the operation information.

7. The determining device according to claim 1, wherein
the first operating device is a turn signal operation device that inputs a direction of a lane change by the vehicle and the vehicle action is the lane change associated with the turn signal operation device, and
the processor is further configured to determine that the driver has requested to carry out manual control of the vehicle action when the direction of the lane change of the vehicle, represented by the operation information, is different from the moving direction of the vehicle toward the destination location of the vehicle, represented in the navigation route.

8. A computer-readable non-transitory storage medium storing a computer program for determination, which causes a processor to execute a process, and the process comprising:
determining whether a driver has requested to carry out automatic control for a vehicle action associated with operation information or the driver has requested to carry out manual control for the vehicle action, based on the operation information representing operation of a first operating device by the driver, and one or more from among action information representing a predetermined driver action by the driver, environment information representing a predetermined environment around the vehicle and a vehicle navigation route.

9. A method for determination carried out by a determining device and the method comprising:
determine whether a driver has requested to carry out automatic control for a vehicle action associated with operation information or the driver has requested to carry out manual control for the vehicle action, based on the operation information representing operation of a first operating device by the driver, and one or more from among action information representing a predetermined driver action by the driver, environment information representing a predetermined environment around the vehicle and a vehicle navigation route.
